(19) United States
(12) Patent Application Publication
(10) Pub. No.: US 2017/0038299 A1
(43) Pub. Date: Feb. 9, 2017

(54) ONLINE PROCESS MONITORING

(71) Applicant: SENTINEL MONITORING SYSTEMS, INC., Tucson, AZ (US)

(72) Inventors: Terry D. Long, Tucson, AZ (US); Frederick N. Bushroe, Tucson, AZ (US); Armand Sperduti, Tucson, AZ (US); William Puent, Marshfield, WI (US); Steven J. Blomquist, Tucson, AZ (US)

(21) Appl. No.: 15/230,243

(22) Filed: Aug. 5, 2016

Related U.S. Application Data
(60) Provisional application No. 62/202,648, filed on Aug. 7, 2015.

(51) Int. Cl. G01N 21/64

(52) U.S. Cl. CPC G01N 21/64; G01N 2021/6419

(57) ABSTRACT

A method to analyze a sample includes performing sample interrogation cycles on the sample to generate replicates. Each of the sample interrogation cycles is performed by: illuminating the sample with two or more fluorescence excitation signals at different wavelengths; and detecting both a fluorescence emission spectral profile and a fluorescence lifetime profile of the sample for each of the two or more fluorescence excitation signals to generate two or more fluorescence emission spectral profiles and two or more fluorescence lifetime profiles of the sample. Each replicate includes the two or more fluorescence emission spectral profiles and the two or more fluorescence lifetime profiles generated for a corresponding one of the sample interrogation cycles. The method includes performing a comparison of the replicates to predetermined spectroscopic relationships. The method includes determining a target analyte concentration of the sample based on the comparison of the replicates to the predetermined spectroscopic relationships.

### CROSS-REFERENCE TO RELATED APPLICATION

This application claims the benefit of and priority to U.S. Provisional App. No. 62/202,648, filed Aug. 7, 2015, which is incorporated herein by reference.

### FIELD

Example embodiments described herein relate to online process monitoring.

### BACKGROUND

Unless otherwise indicated, the materials described in the background section are not prior art to the claims in the present application and are not admitted to be prior art by inclusion in this section.

Companies want to replace their existing quality control labs with systems able to monitor product quality in the production process. Advanced testing and diagnostics systems continue to become physically smaller, more sensitive, and robust enough to be applied outside the core laboratory environment. This trend has been steadily growing within the clinical and industrial markets. Clinical diagnostics may be conducted immediately on patients in physicians' offices and emergency rooms versus waiting days for lab results. Industrial companies are advancing systems to monitor product formulation and quality in real time, increasing manufacturing efficiency and agility. Until recently these advancements have been limited mostly to chemical and materials testing as these are very precise and repeatable.

In comparison, microbiology is messy. Living organisms do not always behave in a predicable manner. Accordingly, microbiology has generally remained “in the lab” and not “on the floor”. Microbiology tests to detect living organisms are often labor intensive, costly, and slow. Results are typically not received for 2-14 days or more depending on what tests are being conducted. Microbiology tests may be critical measures of both product composition and product quality and are often required by law to prove product safety. As a result of inefficiencies and delays associated with such microbiology tests, industry and regulatory authorities are aligned in the desire to migrate testing from retroactive, lab-based testing to real-time monitoring.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter. In an example embodiment, a method to analyze a sample includes performing multiple sample interrogation cycles on the sample to generate multiple replicates, where each of the sample interrogation cycles is performed by: illuminating the sample with two or more fluorescence excitation signals at different fluorescence excitation wavelengths; detecting a fluorescence emission spectral profile of the sample for each of the two or more fluorescence excitation signals to generate two or more fluorescence emission spectral profiles of the sample; and detecting a fluorescence lifetime profile of the sample for each of the two or more fluorescence excitation signals to generate two or more fluorescence lifetime profiles of the sample. Each replicate includes the two or more fluorescence emission spectral profiles and the two or more fluorescence lifetime profiles generated for a corresponding one of the sample interrogation cycles. The method also includes performing a comparison of the replicates to multiple predetermined spectroscopic relationships. The method also includes determining a target analyte concentration of the sample based on the comparison of the replicates to the predetermined spectroscopic relationships.

In another example embodiment, a method to analyze a sample includes performing a sample interrogation cycle on the sample to generate a replicate, where the sample interrogation cycle is performed by: illuminating the sample with two or more fluorescence excitation signals at different fluorescence excitation wavelengths; detecting a fluorescence emission spectral profile of the sample for each of the two or more fluorescence excitation signals to generate two or more fluorescence emission spectral profiles of the sample; and detecting a fluorescence lifetime profile of the sample for each of the two or more fluorescence excitation signals to generate two or more fluorescence lifetime profiles of the sample. The replicate includes the two or more fluorescence emission spectral profiles and the two or more fluorescence lifetime profiles generated for the sample interrogation cycle. The method also includes performing a comparison of the replicate to multiple predetermined spectroscopic relationships. The method also includes determining a target analyte concentration of the sample based on the comparison of the replicate to the predetermined spectroscopic relationships.

In another example embodiment, a process monitor to analyze a sample includes a sample zone, two or more fluorescence excitation sources, one or more detectors, and a controller. The sample is present in the sample zone. The two or more fluorescence excitation sources are optically coupled to the sample zone. The one or more detectors optically is coupled to the sample zone outside an optical path of each of two or more fluorescence excitation signals emitted by the two or more fluorescence excitation sources. The controller is communicatively coupled to each of the two or more fluorescence excitation sources and the one or more detectors and configured to control the processor monitor, including the two or more fluorescence excitation sources and the one or more detectors, to perform various operations. The operations include performing multiple sample interrogation cycles on the sample to generate multiple replicates, where each of the sample interrogation cycles is performed by: illuminating, using the two or more fluorescence excitation sources, the sample with the two or more fluorescence excitation signals at the different fluorescence excitation wavelengths; detecting, using the one or more detectors, a fluorescence emission spectral profile of the sample for each of the two or more fluorescence excitation signals to generate two or more fluorescence emission spectral profiles of the sample; and detecting, using the one or more detectors, a fluorescence lifetime profile of the sample for each of the two or more fluorescence excitation signals to generate two or more fluorescence lifetime profiles of the sample. Each replicate includes the two or more fluorescence emission spectral profiles and the two or more fluorescence lifetime profiles generated for a corresponding one of the sample interrogation cycles. The operations also include performing a comparison of the replicates to multiple predetermined spectroscopic relationships. The operations also include determining a target analyte concentration of the sample based on the comparison of the replicates to the predetermined spectroscopic relationships.

Additional features and advantages of the disclosure will be set forth in the description which follows, and in part will be obvious from the description, or may be learned by the practice of the disclosure. The features and advantages of the disclosure may be realized and obtained by means of the instruments and combinations particularly pointed out in the appended claims. These and other features of the present disclosure will become more fully apparent from the following description and appended claims, or may be learned by the practice of the disclosure as set forth hereinafter.

### BRIEF DESCRIPTION OF THE DRAWINGS

To further clarify the above and other advantages and features of the present disclosure, a more particular description of the disclosure will be rendered by reference to specific embodiments thereof which are illustrated in the appended drawings. It is appreciated that these drawings depict only typical embodiments of the disclosure and are therefore not to be considered limiting of its scope. The disclosure will be described and explained with additional specificity and detail through the use of the accompanying drawings in which:

FIG. 1 is graphic representation depicting how some systems may discriminate target analytes from interfering particles;

FIG. 2 is a graphic representation of fluorescence emission spectral profiles of various target analytes and interfering materials in response to a particular fluorescence excitation wavelength;

FIG. 3 is a graphic representation of fluorescence emission spectral profiles of two target analytes in response to two different fluorescence excitation wavelengths;

FIG. 4 is a graphic representation of fluorescence emission spectral profiles of a target analyte and interfering material from two different fluorescence excitation wavelengths;

FIG. 5 is a graphic representation of fluorescence lifetime profiles of a target analyte and interfering material for 340 nm fluorescence excitation wavelength and 613 nm fluorescence emission wavelength;

FIG. 6 illustrates an example process monitor;

FIG. 7 is a flowchart of a method to analyze a fluid sample, e.g., within a sample zone of FIG. 6;

FIG. 8 illustrates various graphic representations associated with the method of FIG. 7;

FIG. 9 illustrates an example implementation of the process monitor of FIG. 6 and/or of portions thereof;

FIG. 10 illustrates another example implementation of the process monitor of FIG. 6 and/or of portions thereof;

FIG. 11 illustrates another example implementation of the process monitor of FIG. 6 and/or of portions thereof;

FIG. 12 illustrates another example implementation of the process monitor of FIG. 6 and/or of portions thereof;

FIG. 13 illustrates another example implementation of the process monitor of FIG. 6 and/or of portions thereof;

FIG. 14 illustrates another example implementation of the process monitor of FIG. 6 and/or of portions thereof; and

FIG. 15 illustrates another example implementation of the process monitor of FIG. 6 and/or of portions thereof,

all arranged in accordance with at least one embodiment described herein.

### DETAILED DESCRIPTION OF SOME EXAMPLE EMBODIMENTS

Some online water bioburden monitoring systems are based on liquid particle counting technologies with the addition of fluorescence detection. Such systems are severely challenged to meet sensitivity and accuracy requirements due to false positive results generated from interfering materials in water systems that are monitored. Interfering materials may include such things as microscopic particles of Teflon, rubber, plastics, stainless steel, rouge, etc. Such interfering materials may interfere because they may be of similar size as target analytes (e.g., microorganisms) yielding a similar size determination and/or they may have a similar spectral profile as the target analytes in response to a fluorescence excitation signal in these systems. These systems typically include a single excitation source emitting the fluorescence excitation signal on a single fluorescence excitation wavelength (or more particularly a relatively narrow wavelength band), sometimes referred to as an excitation channel.

These systems operate with the following assumptions. First, a particle must be detected (mie scattering). Second, intrinsic fluorescence from target analytes is measurably different from that of interfering materials through specific timing and fluorescence intensity ranges; fluorescence emission from the target analytes may be referred to as a fluorescence signal. Third, background fluorescence from other materials/chemicals in the water does not mask the fluorescence signal of the target analytes.

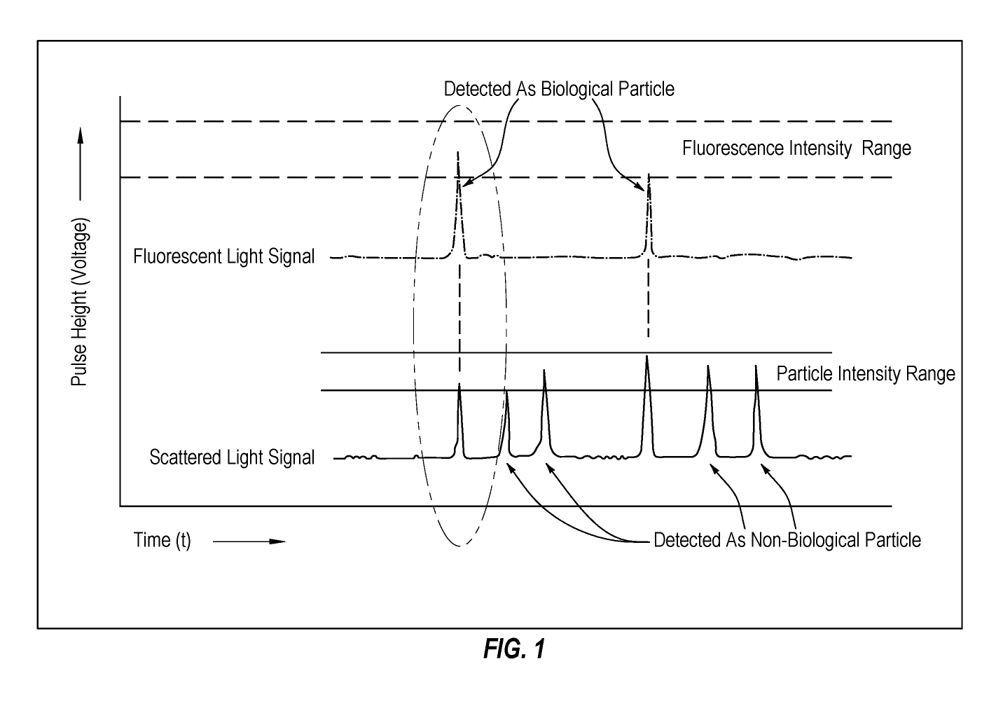

FIG. 1 is graphic representation depicting how these systems may discriminate target analytes from interfering particles. In particular, these systems emit the fluorescence excitation signal into the water and simultaneously detect a fluorescent light signal, a scattered light signal, and particle size. Each of the fluorescent light signal and the scattered light signal may include peaks that correspond to particles detected as a function of time. A value of each peak of the fluorescent light signal may indicate a fluorescence intensity of the corresponding particle. A value of each peak of the scattered light signal may indicate a size of the corresponding particle. Those particles that have a fluorescence intensity within a biological fluorescence intensity range (labeled “Fluorescence Intensity Range” in FIG. 1) and that have a size-to-fluorescence intensity ratio within a ratio range (not shown) may be determined to be target analytes (referred to as “Biological Particle” in FIG. 1). Those particles that have a fluorescence intensity outside the biological fluorescence intensity range and/or that have a size-to-fluorescence intensity ratio outside the ratio range may be determined to be interfering particles (referred to as “Non-Biological Particle” in FIG. 1).

Similar sizes and orientations of target analytes and interfering materials may confound such systems that utilize particle size as a discriminating factor. Additionally, similar fluorescence emission spectral profiles of target analytes and interfering materials may confound such systems that utilize fluorescence intensity as a discriminating factor.

Such systems may be somewhat improved by incorporating multiple excitation sources at different fluorescence excitation wavelengths and multiple resulting fluorescence emission spectral profiles. However, if the target analytes and the interfering materials have similar intrinsic fluorescence characteristics the ability to discriminate between them may be compromised.

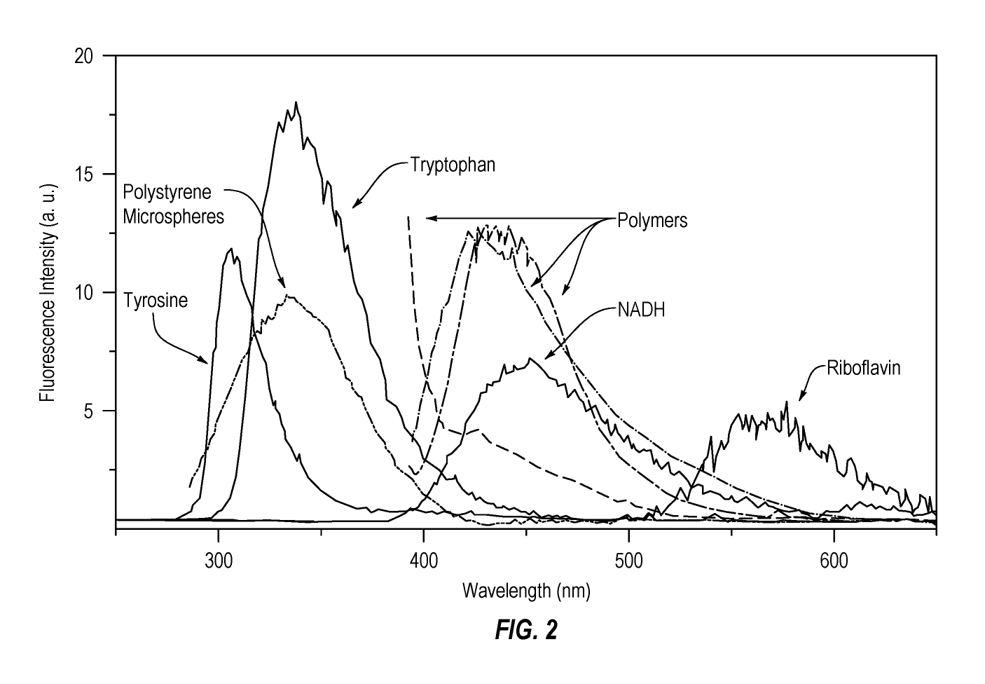

Discrimination between target analytes and interfering materials may be a significant challenge with single fluorescence excitation wavelength systems using particle size as discriminator as microscopic spheres, shavings, and microorganisms may be similar in size, shape, fluorescence emission spectra, and intensity. In particular, the fluorescence emission spectral profiles from interfering materials can interfere with those of target analytes. For example, FIG. 2 is a graphic representation of fluorescence emission spectral profiles of various target analytes and interfering materials in response to a particular fluorescence excitation wavelength. As illustrated in FIG. 2, a depicted fluorescence emission spectral profile of interfering material “Polystyrene Microspheres” significantly overlaps and can interfere with detection of depicted fluorescence emission spectral profiles of target analytes “Tyrosine” and “Tryptophan.” Similarly, various depicted fluorescence emission spectral profiles of interfering materials “Polymers” significantly overlap and can interfere with detection of a depicted fluorescence emission spectral profile of target analyte “NADH.” In FIG. 2, a depicted fluorescence emission spectral profile of target analyte “Riboflavin” is the only one that is not significantly overlapped by fluorescence emission spectral profiles of interfering materials.

The foregoing systems all use continuous single wavelength excitation sources. These systems first detect a particle through Mie scattering and then attempt to discern if intrinsic fluorescence from the particle is unique enough to classify the particle as a target analyte. These systems are confounded by interfering material particles that are too similar in size and fluorescence to distinguish them from target analytes. This creates false positive results which in turn generate unreliable data and unnecessary plant investigations which may be very costly. The industry is still seeking a more reliable, accurate, sensitive solution to online water bioburden monitoring than is currently available with the foregoing systems.

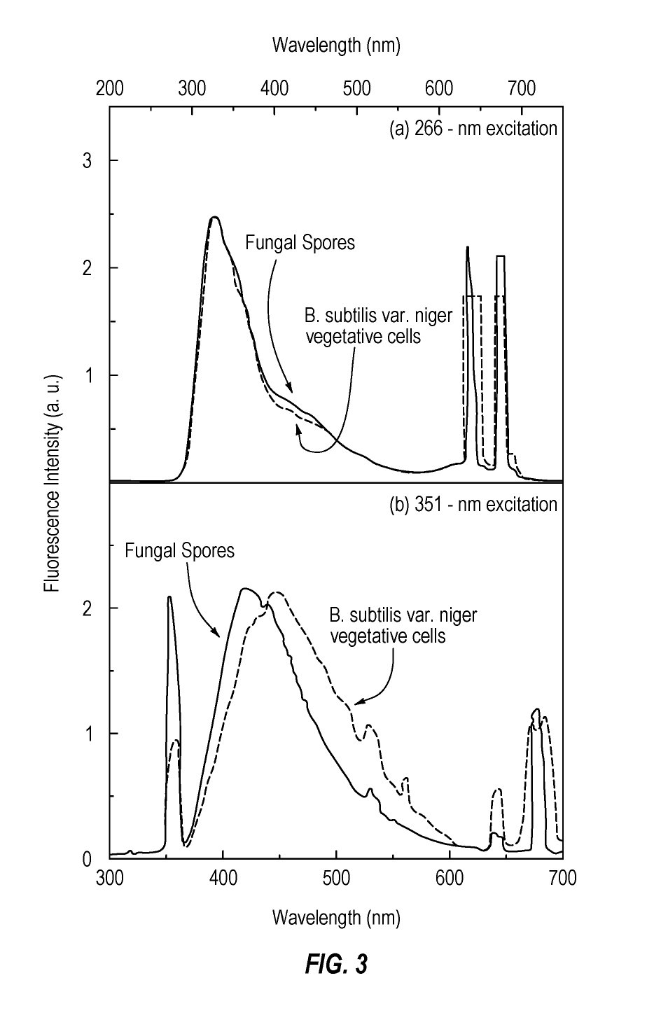

In some cases, multi-wavelength fluorescence excitation can provide more discrimination among target analytes than single-wavelength excitation. For example, FIG. 3 is a graphic representation of fluorescence emission spectral profiles of two target analytes in response to two different fluorescence excitation wavelengths, 266 nanometers (nm) and 351 nm. At the 266 nm fluorescence excitation wavelength, the fluorescence emission spectral profiles of the two target analytes, “Fungal spores” and “B. subtilis var. niger,” are difficult to discriminate. At the 351 nm fluorescence excitation wavelength, the fluorescence emission spectral profiles of the two target analytes are much easier to discriminate as the fluorescence emission spectral profile of the “B. subtilis var. niger” target analyte has peaks that are generally shifted to long wavelengths than peaks of the fluorescence emission spectral profile of the “Fungal spores” target analyte. Alternatively or additionally, multi-wavelength fluorescence excitation—which may also be referred to as multispectral profiling—may also be able to discriminate biological species, sub-species, and potentially individual strains for further use in plant investigations. Multispectral profiling also may be applicable to other monitoring applications such as monitoring concentrations of active ingredients, enzymes, excipients, etc.

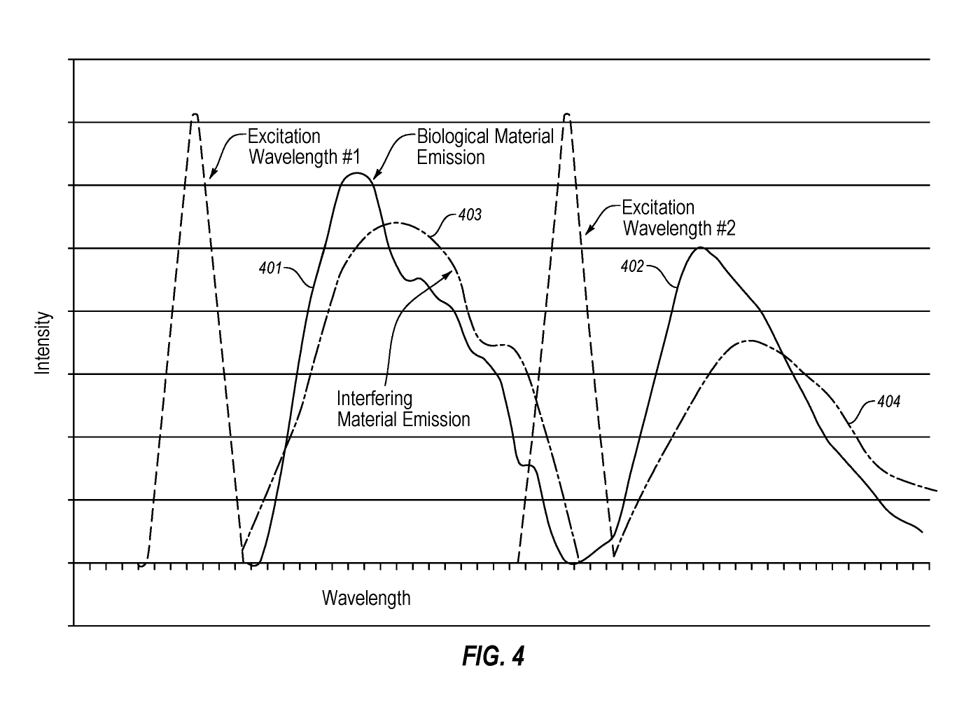

Systems such as those described above that utilize continuous excitation sources may be confounded by inherent background noise and thus may need to increase excitation power to differentiate target signals from noise. This may be problematic to sensitivity if interfering materials have similar emission properties as target analytes. For example, FIG. 4 is a graphic representation of fluorescence emission spectral profiles 401-404 of a target analyte and interfering material from two different fluorescence excitation wavelengths (“Excitation Wavelength #1” and “Excitation Wavelength #2” in FIG. 4). Fluorescence emission spectral profiles 401 and 402 represent the fluorescence spectral response of the target analyte to, respectively, excitation wavelength #1 and excitation wavelength #2. Fluorescence emission spectral profiles 403 and 404 represent the fluorescence spectral response of the interfering material to, respectively, excitation wavelength #1 and excitation wavelength #2. As illustrated in FIG. 4, there is significant overlap between the fluorescence emission spectral profiles 401 and 402 of the target analyte and the fluorescence emission spectral profiles 403 and 404 of the interfering material and there may not be sufficient resolution to efficiently discriminate between the target analyte and the interfering material at either of the fluorescence excitation wavelengths in this example. As a result, interfering materials may be counted as false positives even in systems with multispectral profiling. Alternatively or additionally, lowering excitation power may result in unacceptable sensitivity. In some embodiments described herein, use of pulsed excitation signals and advanced optics may significantly improve the signal-to-noise ratio for applications of interest.

Time-resolved fluorescence spectroscopy is a technique for studying the emission dynamics of fluorescent target analytes, e.g., the distribution of times between the electronic excitation of a fluorophore and the radiative decay of the electron from the excited stated producing emitted photons. The temporal extent of this distribution is referred to as the fluorescence lifetime of the target analyte.

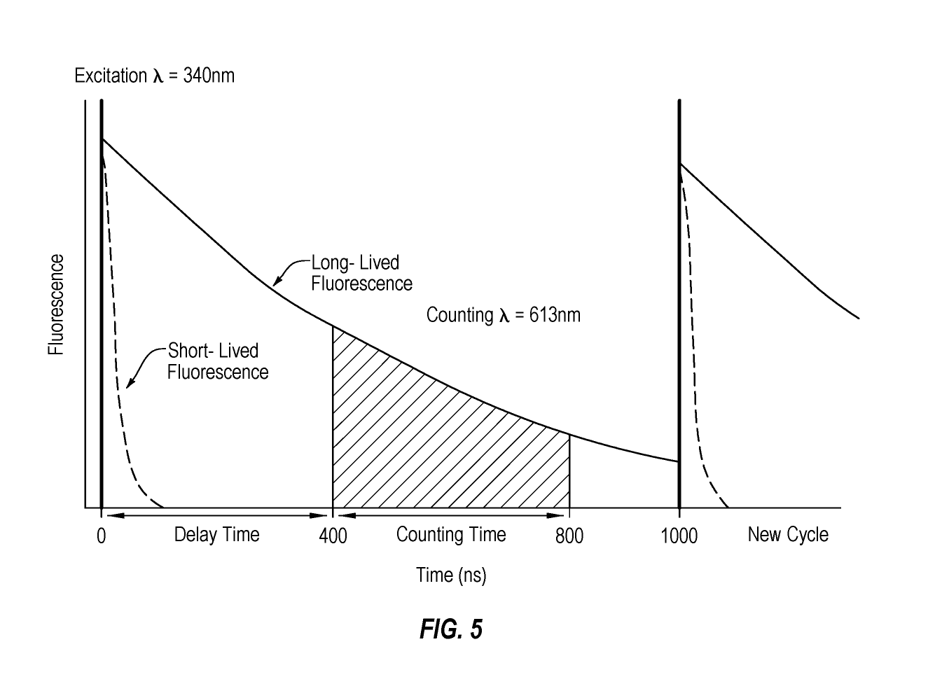

Fluorescence lifetime may be a discernible attribute differentiating target analytes and interfering materials. For example, fluorescence lifetime of biological fluorophores is typically reported at less than 4 nanoseconds, while fluorescence lifetime of interfering fluorophores is typically reported at 5-20 nanoseconds and higher. Such a difference is depicted in FIG. 5, which is a graphic representation of fluorescence lifetime profiles of a target analyte and interfering material for 340 nm fluorescence excitation wavelength and 613 nm fluorescence emission wavelength. It can be seen from FIG. 5 that the fluorescence lifetime profile of the target analyte (labeled “Short-lived fluorescence” in FIG. 5”) is temporally much shorter than the fluorescence lifetime profile of the interfering material (labeled “Long-lived fluorescence” in FIG. 5). The use of temporal profiles to discriminate between different target analytes and/or between a target analyte and interfering material may be referred to hereinafter as multitemporal profiling.

Accordingly, embodiments described herein implement both multispectral profiling and multitemporal profiling, collectively referenced as multivariate methods or multivariate profiling. Some embodiments described herein build up a more complete (multivariate) description of the complex fluorescence profile within a sample. This may be obtained by fitting multiple replicates of discrete multispectral and temporal decay profiles to a database of spectroscopic relationships. In these and other embodiments, detected signals may have relatively weak signal intensities as a result of, e.g., relatively low concentrations of target analytes. Embodiments described herein may establish sufficient signal quality by using high-speed, multiple replicate analysis to enhance the signal quality, as described in more detail below.

Some embodiments may include a multiplex detector assembly and high speed signal processing electronics to maximize or enhance the signal-to-noise ratio specific to a detection channel for each of multiple sample interrogation cycles. The multiplex detector assembly and high speed signal processing electronics may facilitate rapid analytical cycles to facilitate replicate analysis in a short analytical time period and maximize or at least enhance signal-to-noise ratio. In addition, data may be acquired from a sample without implementing an excitation event to acquire a baseline or background noise of the system, which can be used to compensate for biases or noise inherent to the system that are not actively part of interrogation events.

Some embodiments may deliver instantaneous or real-time (or near instantaneous or near real-time) spectroscopic analysis of the sample and perform multiple replicates of the analysis in sub-millisecond cycles for increased statistical confidence. Accordingly, some monitoring systems described herein may have the sensitivity, accuracy, specificity, precision, and robustness required for online, at-line, and laboratory water bioburden monitoring applications. Alternatively or additionally, the monitoring systems described herein may include the ability to “tune” the system to detect and quantify specific target analytes such as active ingredients and sterility monitoring applications. Tuning the system may include evaluating a pure sample of the target analyte(s) in the specific system matrix to establish an identification signature or fingerprint. Tuning the system may also include utilization of statistical procedures to convert observations from the system into correlated or uncorrelated variables as in principle component analyses or similar eigenvector based multivariate analyses. Alternatively or additionally, artificial intelligence learning algorithms may be utilized to determine spectroscopic relationships and/or evaluate the detection signals for characteristic response signatures or fingerprints of one or more target analytes and/or interfering materials.

In some embodiments described herein, the difference in fluorescent decay rates of target analytes and interfering materials may be a valuable discriminatory platform within industrial applications of interest. Some embodiments may detect this difference and add the temporal analysis to multispectral dimensions of multiple excitation wavelengths (or excitation channels) and specific emission detection wavelength sub-bands (or detection channels). Some embodiments may complete this multivariate analysis cycle in less than 500 nanoseconds (ns), allowing multiple replicates (e.g., >10) to be completed and compared while the target is within the sample analysis zone.

Reference will now be made to the drawings to describe various aspects of some example embodiments of the invention. The drawings are diagrammatic and schematic representations of such example embodiments, and are not limiting of the present invention, nor are they necessarily drawn to scale.

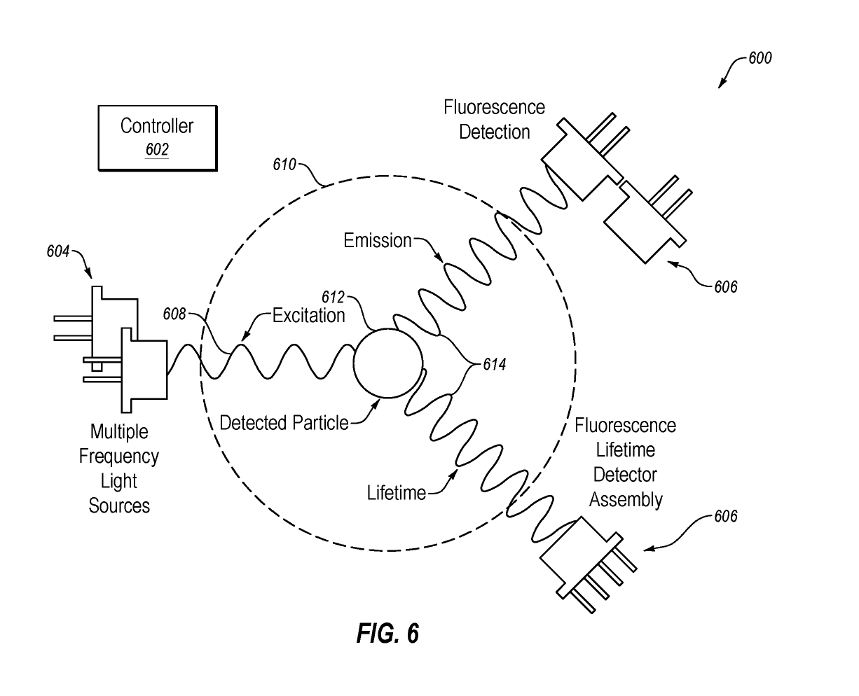

FIG. 6 illustrates an example process monitor 600, arranged in accordance with at least one embodiment described herein. The process monitor 600 may be implemented for online water bioburden monitoring (e.g., monitoring of bioburden in water) and/or for monitoring of other target analytes in other fluids, gases, or the like. Examples of target analytes include microorganisms, active ingredients, enzymes, excipients, or other target analytes.

The process monitor 600 may include a controller 602, multiple fluorescence excitation sources 604, and one or more detectors 606. The controller 602 may be communicably coupled to the fluorescence excitation sources 604, the detectors 606, and/or to one or more driver circuits, amplifier circuits, or other components to control operation of the process monitor 600. The controller 602 may include a processor, a microprocessor, a microcontroller, a digital signal processor (DSP), an application specific integrated circuit (ASIC), a field programmable gate array (FPGA), or other suitable controller.

Each of the fluorescence excitation sources 604 may be configured to emit a fluorescence excitation signal 608 at different fluorescence excitation wavelengths. Each of the fluorescence excitation sources 604 may include a light emitting diode (LED), a laser diode such as a vertical cavity surface emitting laser (VCSEL) or edge emitting semiconductor laser, or other suitable fluorescence excitation source configured to emit fluorescence excitation signals 608 at a desired fluorescence excitation wavelength and with a relatively short fall time. Relatively short fall times may include fall times less than a few ns, fall times less than or equal to about 1.5 ns, sub-ns fall times, or even shorter fall times. In at least one embodiment, one of the fluorescence excitation sources 604 may emit at a wavelength of 405 nm or other suitable wavelength, while the other of the excitation sources 604 may emit at a wavelength of 635 nm or other suitable wavelength. Only two excitation sources 604 are illustrated in FIG. 6, but the process system 600 may alternatively include three, four, five, or even more excitation sources 604 that emit at different fluorescence excitation wavelengths.

The controller 602 may be configured to cycle the fluorescence excitation sources 604 at high frequencies to, e.g., sequentially emit corresponding fluorescence excitation signals 608 with limited pulse widths as opposed to use of a single continuous wave signal as in some other systems described above. High frequencies may include frequencies greater than 0.1 megahertz (MHz). Pulse widths of the fluorescence excitation signals 608 may be controlled by the controller 602 to be between 1 ns and 50 ns or within some other suitable range. Intensities of the fluorescence excitation signals 608 may be controlled by the controller 602 to be sufficient to elicit fluorescent emissions from the target analytes.

The fluorescence excitation sources 604 may be controlled by the controller 602 to emit the fluorescence excitation signals 608 sequentially and without temporal overlap in some embodiments. E.g., the fluorescence excitation sources 604 may be controlled such that no more than one of them is emitting at any given time. One or more of the fluorescence excitation signals 608 may be at a resonant frequency (or corresponding wavelength) of one or more expected target analytes to elicit an enhanced fluorescence response from the particle 612 if the particle 612 is one of the expected target analytes. In some embodiments, the fluorescence excitation sources 604 may be controlled to emit the fluorescence excitation signals 608 in an oscillatory or cyclical manner to elicit an enhanced specific fluorescence resonant response from expected target analytes.

Alternatively or additionally, detection by the detectors 606 may occur in the dark, e.g., without any of the fluorescence excitation sources 604 emitting fluorescence excitation signals 608 during detection. Accordingly, the controller 602 may control the fluorescence excitations sources 604 to sequentially emit the fluorescence excitation signals 608 without temporal overlap and with a temporal break between the end of one pulse and the beginning of the next pulse to allow for detection in the dark.

The fluorescence excitation sources 604 may emit the fluorescence excitation signals into a sample zone 610 of the process monitor 600. The sample zone 610 may include a portion of a flow cell between the fluorescence excitation sources 604 and the detectors 606. A portion or “sample” of a substance (in any phase, e.g., solid, liquid, gas) being monitored may be present within the sample zone 610 and may include one or more target analytes and/or particles 612 (hereinafter “particle 612” or “particles 612”) that fluoresce in response to one or more of the fluorescence excitation signals 608. For simplicity in the discussion that follows, reference is made to detection and/or fluorescence of particles, although the discussion also applies to detection and/or fluorescence of target analytes.

Each of the detectors 606 may include a photodiode, such as a positive-intrinsic-negative (PIN) diode or avalanche photodiode (APD), a photo multiplier tube (PMT), a Silicon photo multiplier (SiPMT), or other suitable detector to detect fluorescence emission signals 614 emitted by the particles 612 in response to the fluorescence excitation signals 608. In some embodiments, the process monitor 600 is designed to minimize, or at least reduce, transmission of the fluorescence excitation signals 608 into the detectors 606 to minimize, or at least reduce, detection by the detectors 606 of background signals, e.g., signals other than the fluorescence emission signals 614, such as the fluorescence excitation signals 608. For example, the detectors 606 and/or optics that collect and direct the fluorescence emission signals 614 to the detectors 606 may be positioned out of an optical path the fluorescence excitation signals 608 would otherwise travel through the sample zone 610 absent interaction with the particles 612.

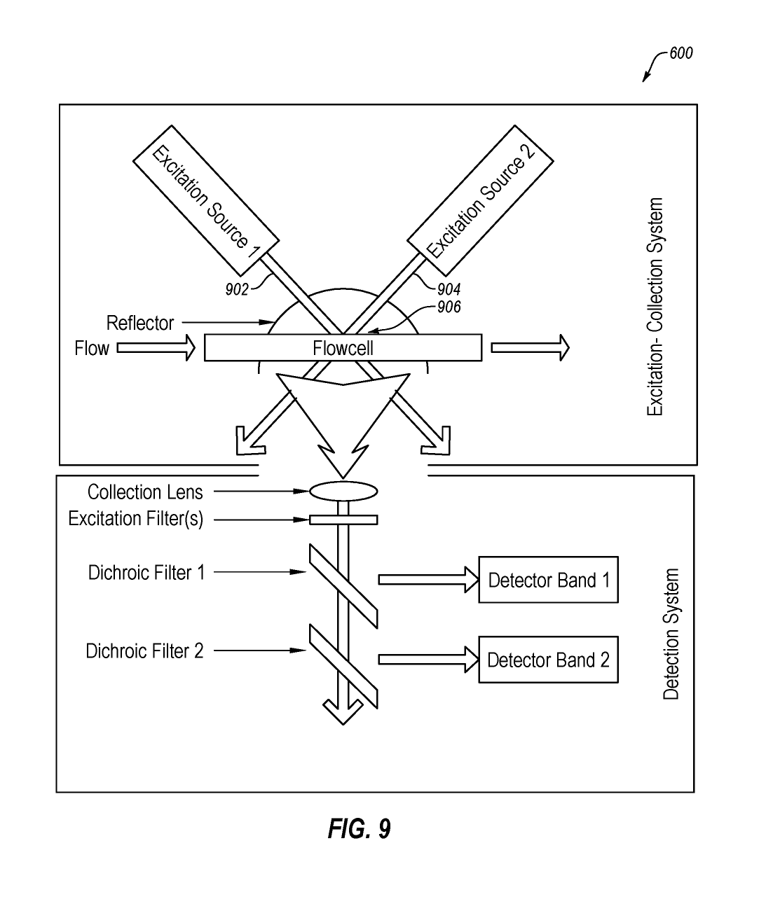

An optical detection system of the process monitor 600, including the detectors 606 and the optics that collect and direct the fluorescence emission signals 614 to the detectors 606, may be configured to separately detect multiple spectral sub-bands of fluorescence emission spectral profiles of the particles 612. The different spectral sub-bands may be referred to as detection channels. In some embodiments, different detectors 606 may detect different spectral sub-bands and/or the fluorescence lifetime profile of fluorescence emitted by the particle 612 within each of the sub-bands. Alternatively or additionally, a single detector 606 may detect two or more of the sub-bands and/or the fluorescence lifetime profile, e.g., by using two or more optical delay lines (e.g., optical fibers or optical paths of different lengths) and/or other optical delay means to temporally separate arrival and detection of the various sub-band components at the single detector 606. In these and other embodiments, the optical detection system may include one or more optical bandpass filters (e.g., dichroic filters), optical fibers, optical paths, light guides (LGs), light pipes, beam splitters, prisms, mosaic filters, multivariate optical elements (MOEs), photonic crystal (PC) fibers, LG or PC waveguides or PC fibers, PC optics, lenses, and/or other suitable optical devices. Various example configurations of the process monitor 600 including one or more of the foregoing components are described below with respect to FIGS. 9-15.

A total number of the detection channels detected by the one or more detectors 606 of the process monitor 600 may be relatively small, such as three detection channels in an embodiment to monitor water bioburden in a water purification process. In this example, the process monitor 600 is, in effect, a 3-channel spectrometer as it detects on three distinct sub-bands or detection channels. The resolution of a 3-channel spectrometer to discriminate may be somewhat limited, which can be improved by addition of the fluorescence lifetime profile as described herein. The 3-channel spectrometer would still be challenged to effectively quantify and discriminate target analyte from interfering material if a large volume, e.g., 1 liter, of water with both target analyte and interfering material were present in the sample zone 610. As such, in some embodiments, a volume of the sample zone 610 may be relatively small when the number of the detection channels is relatively small. In the present example, the volume of the sample zone 610 may be about 1 microliter or other suitable volume to minimize a probability of having a large amount of either or both target analyte and interfering material present in the sample zone 610. This may result in a small amount of target analyte and/or interfering material being present in the sample zone 610, which may make it difficult to establish sufficient signal quality. Embodiments described herein may establish sufficient signal quality by using high-speed, multiple replicate analysis to enhance the signal quality. For instance, the fluid sample in the sample zone 610 of 1 microliter in this case may be analyzed numerous times (e.g., 1,000-2,000 times) as particles 612 traverse the sample zone 610 to generate the equivalent of a high detail signal.

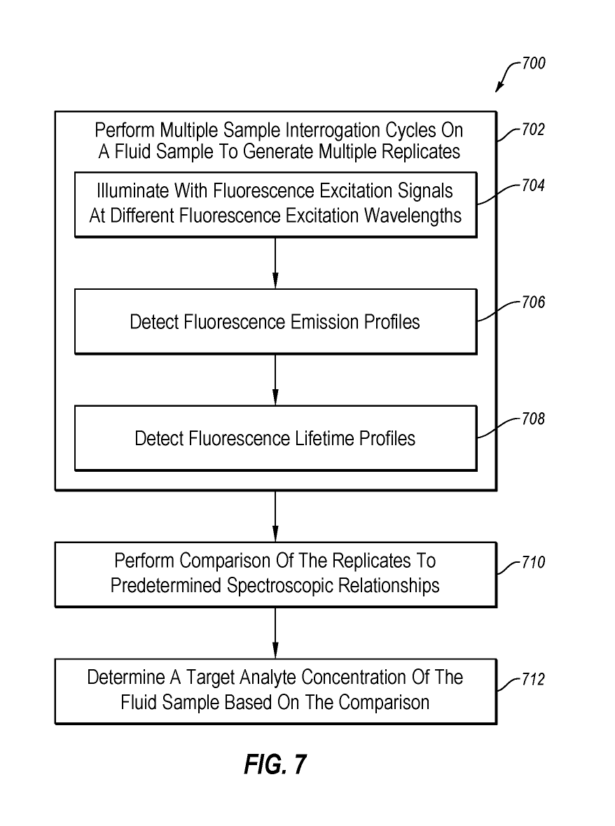

FIG. 7 is a flowchart of a method 700 to analyze a fluid sample, e.g., within the sample zone 610 of FIG. 6, arranged in accordance with at least one embodiment described herein. The method 700 may be implemented by the process monitor 600 of FIG. 6 or other process monitors described herein. Alternatively or additionally, the method 700 may be applied to analyze a gas sample or a solid sample of another substance, including flowing powders, pills on a conveyer line, pastes, or other substance in any phase. In some embodiments, performance of the method 700 may be controlled by, e.g., the controller 602 of FIG. 6 or another processor that executes computer-readable instructions (e.g., code or software) stored on a non-transitory computer-readable medium (e.g., computer memory or storage) to control the process monitor 600 to perform the method 700.

With combined reference to FIGS. 6 and 7, the method 700 may include the process monitor 600 performing one or more sample interrogation cycles on a fluid sample in the sample zone 610 to generate one or more replicates at block 702. Performing each interrogation cycle may include one or more of blocks 704, 706, and/or 708. In the discussion that follows, it is assumed that multiple interrogation cycles are performed to generate multiple replicates. In other embodiments, a single interrogation cycle is performed to generate a single replicate.

At block 704, the fluid sample in the sample zone 610 may be illuminated with two or more fluorescence excitation signals 608 at different fluorescence excitation wavelengths. The illuminating may include sequentially illuminating the fluid sample in the sample zone 610 with the two or more fluorescence excitation signals 608 without temporal overlap. In other embodiments, the illuminating may include simultaneously illuminating the fluid sample in the sample zone 610 with at least two fluorescence excitation signals at different fluorescence excitation wavelengths. Alternatively or additionally, the two or more fluorescence excitation signals 608 may be pulsed in each of the interrogation cycles and there may be a temporal break between the end of a pulse of one of the fluorescence excitation signals 608 and the beginning of a pulse of another of the fluorescence excitation signals 608 to allow for detection in the dark. Detection may occur continuously, or may begin at or about the same time each pulse ends or even after each pulse ends and may terminate at or about the same time the next pulse begins or even before the next pulse begins.

At block 706, a different fluorescence emission spectral profile of the fluid sample may be detected from the different fluorescence emission signals 614 after illumination by each of the fluorescence excitation signals 608. For example, after illumination by one of the fluorescence excitation signals 608, the particle 612 may emit a corresponding fluorescence emission signal 614 and its corresponding fluorescence emission spectral profile may be detected by one of the detectors 606. After illumination by another of the fluorescence excitation signals 608, the particle 612 may emit another fluorescence emission signal 614 and its corresponding fluorescence emission spectral profile may be detected by another of the detectors 606 (or by the same detector 606 where only a single detector 606 is present). The result may be generation of two or more fluorescence emission spectral profiles, each generated in response to illumination by a corresponding one of the fluorescence excitation signals 608 or in response to simultaneous illumination by at least two of the fluorescence excitation signals 608. Detecting each of the fluorescence emission spectral profiles at block 706 may include, for each of the fluorescence emission spectral profiles, separately detecting multiple spectral sub-bands of the corresponding fluorescence emission spectral profile.

At block 708, a different fluorescence lifetime profile of the fluid sample may be detected from the different fluorescence emission signals 614 after illumination by each of the fluorescence excitation signals 608. For instance, after illumination by one of the fluorescence excitation signals 608, the particle 612 may emit a corresponding fluorescence emission signal 614 and its corresponding fluorescence lifetime profile may be detected by one of the detectors 606. After illumination by another of the fluorescence excitation signals 608, the particle 612 may emit another fluorescence emission signal 614 and its corresponding fluorescence lifetime profile may be detected by another of the detectors 606 (or by the same detector 606 where only a single detector 606 is present). The result may be generation of two or more fluorescence lifetime profiles, each generated in response to illumination of the particle 612 by a corresponding one of the fluorescence excitation signals 608 or in response to simultaneous illumination by at least two of the fluorescence excitation signals 608.

Each sample interrogation cycle performed at block 702—including blocks 704, 706, and 708—may generate a corresponding replicate. Each replicate may include the two or more fluorescence emission spectral profiles and the two or more fluorescence lifetime profiles generated for the corresponding sample interrogation cycle.

At block 710, a comparison of the replicates to predetermined spectroscopic relationships may be performed. Comparing the replicates to the predetermined spectroscopic relationships may include comparing an average or composite signal derived from the replicates to the predetermined spectroscopic relationships. Alternatively or additionally, comparing the replicates to the predetermined spectroscopic relationships may include fitting the replicates (e.g., the average or composite signal) to the predetermined spectroscopic relationships to identify the one or more particles 612 present in the fluid sample as target analytes.

The predetermined spectroscopic relationships may be stored in a database and/or may be accessible to the process monitor 600 or a computer device communicatively coupled to the process monitor 600. The predetermined spectroscopic relationships may establish characteristic response signatures or fingerprints of one or more target analytes and/or interfering materials and may be referred to as characteristic response signature emission profiles. Alternatively or additionally, artificial intelligence learning algorithms may be utilized to determine spectroscopic relationships and/or evaluate the detection signals for characteristic response signatures or fingerprints of one or more target analytes and/or interfering materials. The multivariate (e.g., multispectral and multitemporal) fluorescence profiles, e.g., the replicates, may be compared against or fitted to the predetermined spectroscopic relationships to identify the one or more particles 612 present in the fluid sample as target analytes by, e.g., comparing attributes/characteristics of the replicates or of the average or composite signal to corresponding attributes/characteristics of the characteristic response signature emission profiles in various sub-bands and/or time periods. For example, if an average or composite fluorescence emission spectral profile and/or an average or composite fluorescence lifetime profile of the replicates matches (e.g., in spectral profile shape/correspondence between emission wavelength and intensity and/or in lifetime profile shape/correspondence between decay time and intensity) a fluorescence emission spectral profile and/or lifetime profile of a target analyte included in the characteristic response signature emission profiles, the target analyte may be identified as being present in the fluid sample.

At block 712, a target analyte concentration of the fluid sample may be determined based on comparison of intensity of the characteristic response signature emission profile of one or more target analytes or interfering materials determined to be present to intensity in the replicates from the interrogated sample. Determining the target analyte concentration may include determining the bioburden concentration. The comparison to determine target analyte concentration may be included in or as part of the comparison of block 710. In these and other embodiments, the characteristic response signature emission profile may be indicative of the multivariate response of a single particle (or other known number of particles) of target analyte or interfering material. A greater concentration of target analyte or interfering material in the fluid sample may elicit a fluorescence emission spectral profile and/or fluorescence lifetime profile that matches, in shape and/or other attributes, a portion of the characteristic response signature emission profile but with a greater intensity. The intensity of the replicates (or average or composite signal derived therefrom) may change linearly or according to some other know relationship compared to the intensity in the characteristic response signature emission profile as a function of the amount or concentration of particles of the target analyte present in the fluid sample. Thus, a number or concentration of particles of the target analyte may thereby be determined by comparing intensity of the characteristic response signature emission profile to intensity of the replicates. In some embodiments, the determined concentration may be “totalized” over time to relate it to a larger volume (than is present in the fluid sample) or time value. Alternatively or additionally, the method 700 may further include determining the bioburden concentration of a particular type of target analyte in the fluid sample.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

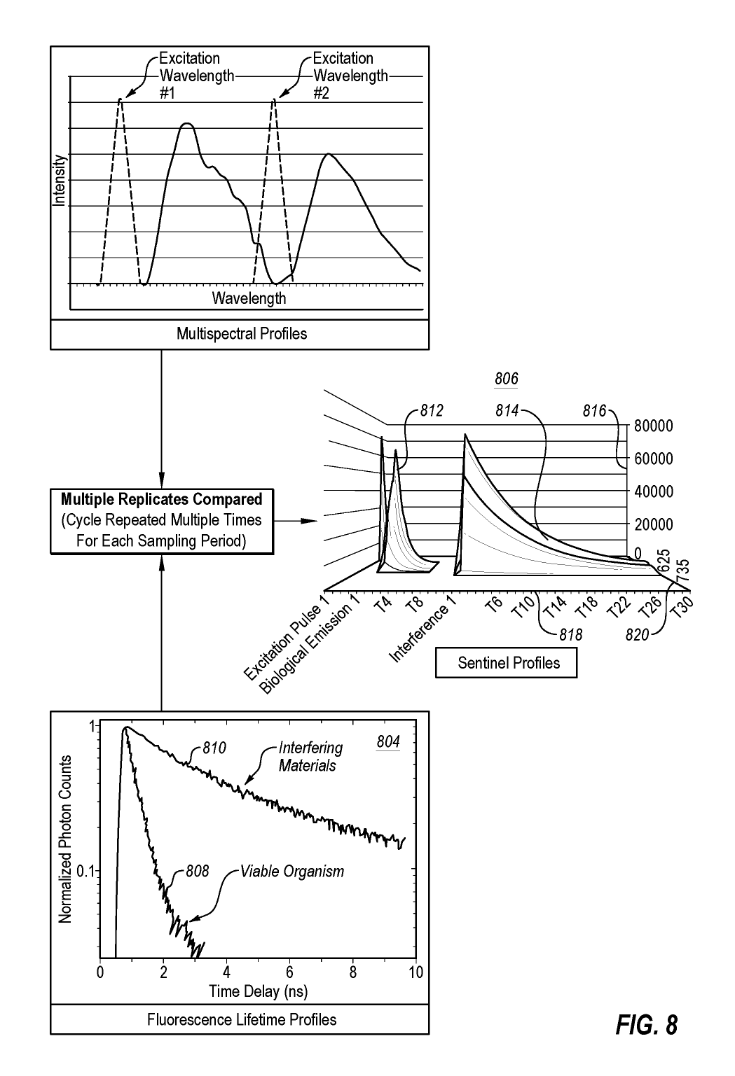

Aspects of the method 700 are described in more detail with respect to FIG. 8, which illustrates various graphic representations 802, 804, 806, arranged in accordance with at least one embodiment described herein. The graphic representation 802 includes the fluorescence emission spectral profiles 401 and 402 of FIG. 4 that may be generated in one sample interrogation cycle of FIG. 7 in response to illumination of the fluid sample with two fluorescence excitation signals at “Excitation Wavelength #1” and “Excitation Wavelength #2” if a particle or particles of the target analyte are present in the fluid sample.

The graphic representation 804 includes a fluorescence lifetime profile 808 of the target analyte and a fluorescence lifetime profile 810 of an interfering material. At least one of the fluorescence lifetime profile 808 of the target analyte or the fluorescence lifetime profile 810 of the interfering material may be generated in one sample interrogation cycle in response to illumination of the fluid sample by one of the two fluorescence excitation signals at “Excitation Wavelength #1” and “Excitation Wavelength #2.” A separate fluorescence lifetime profile 808 or 810 for at least one of the target analyte or the interfering material may be generated during the sample interrogation cycle in response to illumination of the fluid sample by the other of the two fluorescence excitation signals. Where particles of both the target analyte and the interfering material are present in the fluid sample during the interrogation cycle, the detected fluorescence lifetime profile may be a composite of the fluorescence lifetime profiles 808 and 810.

The graphic representation 806 includes a joint fluorescence emission spectral and lifetime profile (hereinafter “profile” or “profiles”) 812 and 814 for, respectively, the target analyte and the interfering material. The graphic representation 806 is a 3D graph in which a first axis 816 corresponds to intensity, a second axis 818 corresponds to time in nanoseconds, and a third axis 820 corresponds to emission wavelength in nm. Along the second axis 818, the initial time value (e.g., at far left of the second axis 818) is 0 for the joint fluorescence emission spectral and lifetime profile 812 of the target analyte and increases to the right. The time value along the second axis 818 resets to 0 at far left of the joint fluorescence emission spectral and lifetime profile 814 of the interfering material and increases to the right.

The profiles 812 and 814 are examples of predetermined spectroscopic relationships, each of which establishes a multivariate signature or fingerprint for a corresponding one of the target analyte and the interfering material. The various replicates generated during block 702 of the method 700 of FIG. 7, including two or more fluorescence emission spectral profiles (e.g., 401 and 402) and two or more fluorescence lifetime profiles (e.g., 808 and/or 810) generated during each interrogation cycle, may be compared against the profiles 812 and 814 or characteristics thereof to determine a bioburden of the fluid sample.

FIGS. 9-15 illustrate various example implementations of the process monitor 600 of FIG. 6 and/or of portions thereof, arranged in accordance with at least one embodiment described herein. In general, the process monitor 600 may be at least logically divided into an excitation collection system and a detection system.

In the embodiment of FIG. 9, the excitation collection system of the process monitor 600 includes two fluorescence excitation sources (“Excitation Source 1” and “Excitation Source 2” in FIG. 9 and other Figures) that emit fluorescence excitation signals 902 and 904 into a sample zone 906 of a flowcell. The sample zone 906 may be at least partially surrounded by a reflector to focus fluorescence emission signals into a collection lens (labeled “Collection lens” in FIG. 9 and other Figures) of the detection system. The reflector may be transmissive to the fluorescence excitation signals and reflective to the fluorescence emission signals. The embodiment of FIG. 9 may minimize transmission of the fluorescence excitation signals 902 and 904 into the detection system by directing the fluorescence excitation signals 902 and 904 out of a detection path, as illustrated in FIG. 9.

The collection lens in FIG. 9 or other figures may have both a light entrance surface and a light exit surface. The light entrance surface may be convex, concave, aspheric, plano, or other suitable shape. Analogously, the light exit surface may be convex, concave, aspheric, plano, or other suitable shape. In these and other embodiments, the collection lens may have a net positive optical power. Accordingly, at least one of the light entrance or light exit surfaces of the collection lens may be convex or aspheric or other shape with positive optical power, while the other of the light entrance or light exit surfaces may be convex, concave, aspheric, plano, or other shape with any optical power which summed with the positive optical power is still net positive.

An excitation filter following the collimating lens may filter out wavelengths of light outside an expected fluorescence emission signal spectrum. A first dichroic filter (e.g. beam splitter) (“Dichroic Filter 1” in FIG. 9) may be a bandpass filter that redirects one sub-band to a first detector (“Detector band1” in FIG. 9) and allows other wavelengths to pass. A second dichroic filter (“Dichroic Filter 2” in FIG. 9) may be another bandpass filter that redirects another sub-band to a second detector (“Detector band2” in FIG. 9) and allows other wavelengths to pass.

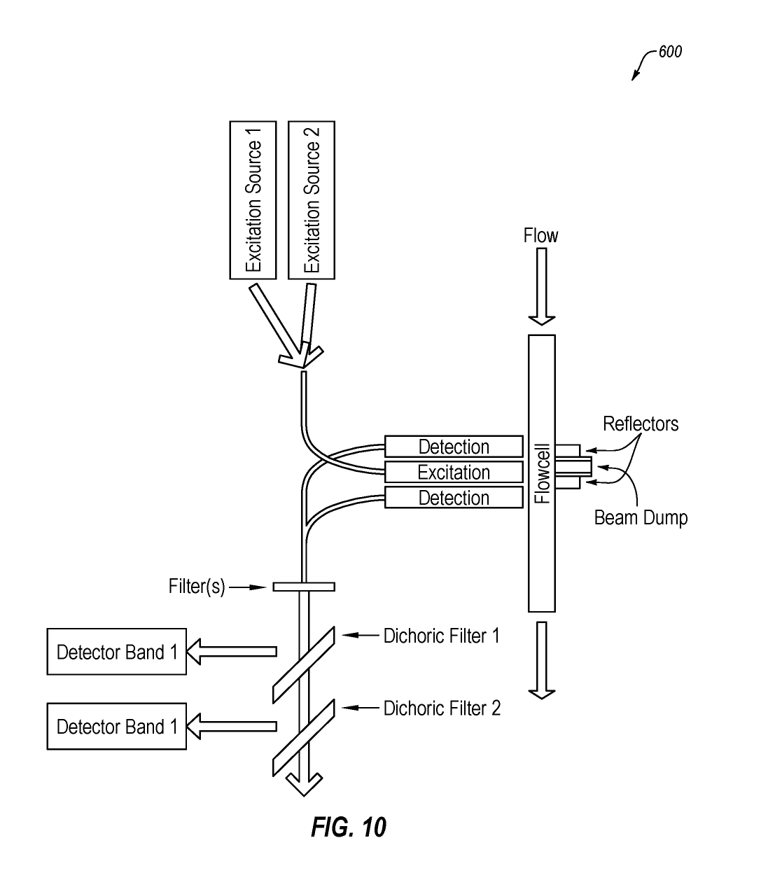

In FIGS. 10-15, similar names and/or references numbers as used elsewhere herein denote similar components. In the example of FIG. 10, the process monitor 600 may leverage light pipe methodologies to controllably direct fluorescence excitation signals through the system flowcell as illustrated in FIG. 10. In FIGS. 9-15, an output after an excitation filter (where one is present) could be coupled to a light guide, or fiber bundle, then split into 2 or more legs going to the detectors, with individual filters between the light guide and detector, or filters in the separate legs, or each leg of the light guide could have inherent filter properties, such as a molded light guide made of a polymer (low cost) or glass with absorptive dye in the light guide material.

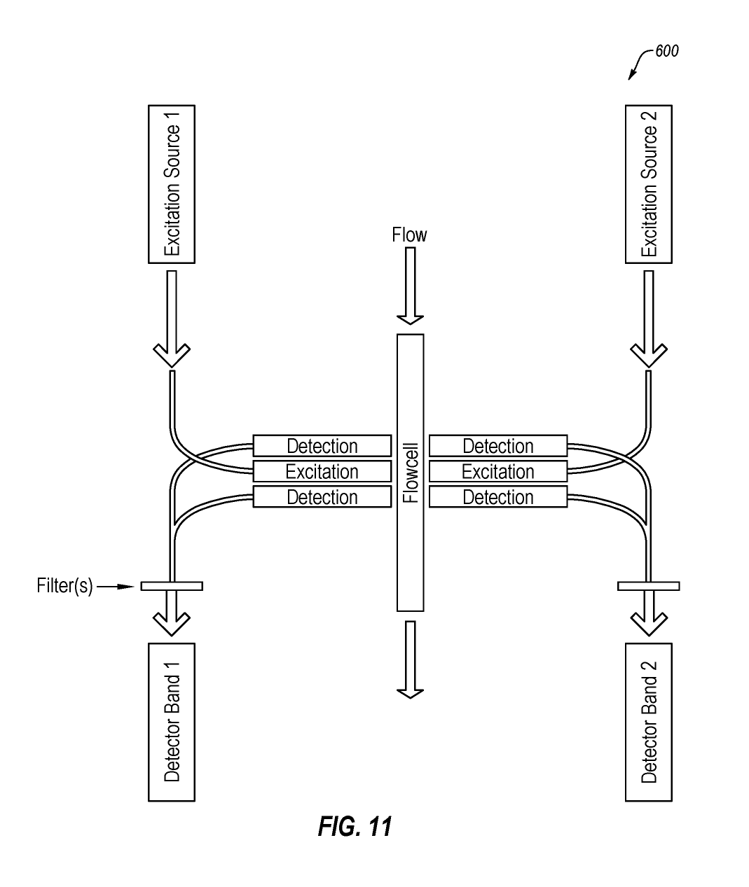

In the example of FIG. 11, the process monitor 600 leverages light pipe methodologies to controllably direct fluorescence excitation signals through the system flowcell in a different manner than is illustrated in FIG. 10.

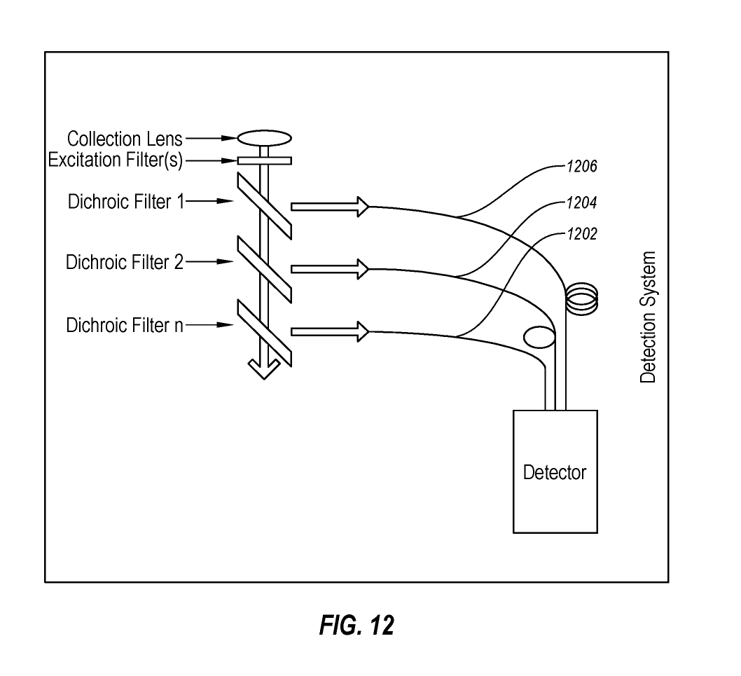

FIGS. 12-15 illustrate various configurations of the detector system that may be included in the process monitor 600. In these and other embodiments, dichroic filer(s) can be replaced by a cube beam splitter or an array of cube beam splitters loose or adhered together. Alternately a prism assembly with a filter function can be used, such as a K-Prism or Phillips prism configuration, or an X-cube configuration with appropriate filter functions may be applied. These prisms can also be extended in an array like fashion. Detectors can receive fluorescence emission signals from the prisms via proximity focus (e.g., butt-coupled), lenses or fibers.

In FIG. 12, optical fiber methodologies may be leveraged to controllably delay the desired sub-bands to a single detector. For example, optical fibers 1202, 1204, 1206 may have different lengths. Compared to the optical fiber 1202, longer lengths of the optical fibers 1204, 1206 may introduce different and known delays of fluorescence emission signals (or sub-bands thereof) that are transmitted from the excitation collection system (see, e.g., FIG. 10) to the detector of FIG. 12. By introducing delays into the sub-bands, a single detector can be used to detect multiple sub-bands.

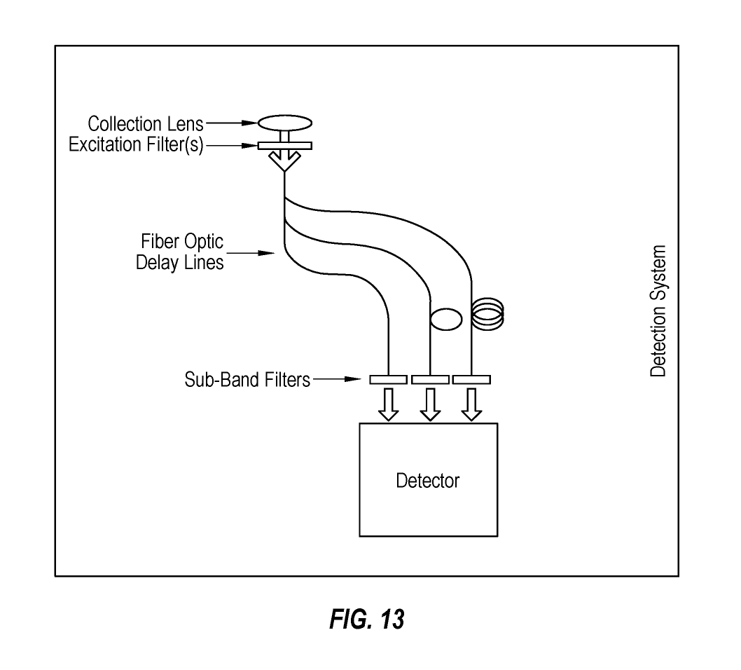

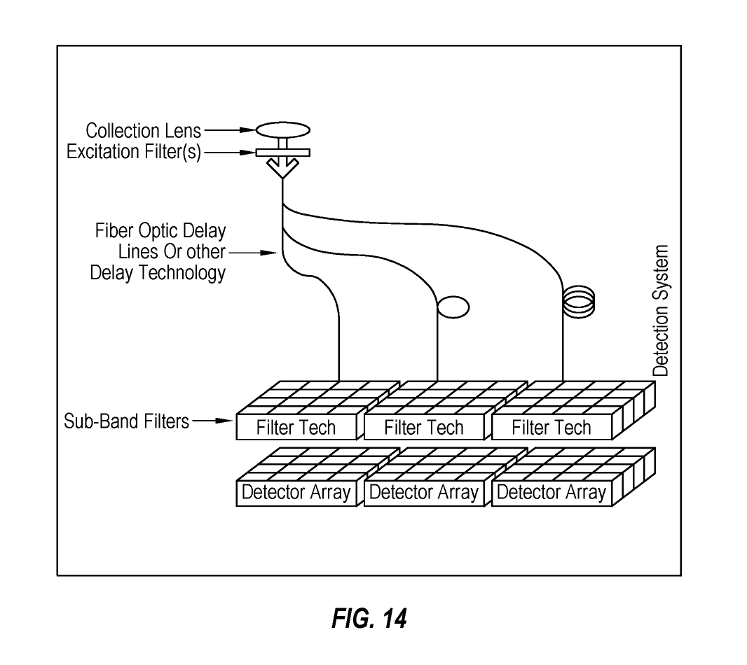

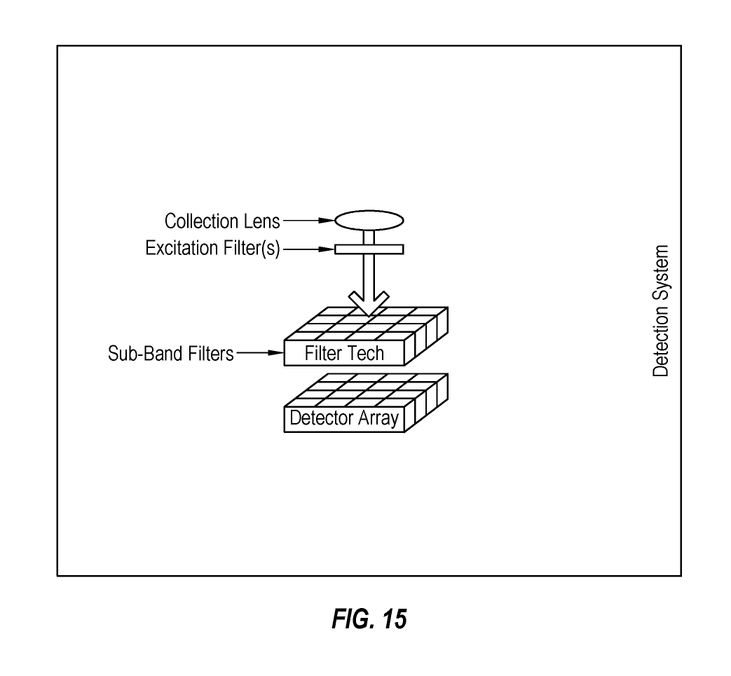

FIG. 13 illustrates another configuration of a detector system that leverages optical fiber methodologies to controllably delay the desired sub-bands to a single detector. FIG. 14 illustrates a configuration of a detector system that leverages optical fiber methodologies to controllably delay the desired sub-bands to a detector array with filter technologies such as mosaic filters. FIG. 15 illustrates a configuration of a detector system without optical delay and with a detector array with filter technologies such as mosaic filters.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method to analyze a sample, the method comprising:
performing a plurality of sample interrogation cycles on the sample to generate multiple replicates, wherein each of the plurality of sample interrogation cycles is performed by:
illuminating the sample with two or more fluorescence excitation signals at different fluorescence excitation wavelengths;
detecting a fluorescence emission spectral profile of the sample for each of the two or more fluorescence excitation signals to generate two or more fluorescence emission spectral profiles of the sample; and
detecting a fluorescence lifetime profile of the sample for each of the two or more fluorescence excitation signals to generate two or more fluorescence lifetime profiles of the sample;
wherein each replicate of the multiple replicates includes the two or more fluorescence emission spectral profiles and the two or more fluorescence lifetime profiles generated for a corresponding one of the plurality of sample interrogation cycles;
performing a comparison of the multiple replicates to a plurality of predetermined spectroscopic relationships; and
determining a target analyte concentration of the sample based on the comparison of the multiple replicates to the plurality of predetermined spectroscopic relationships.

2. The method of claim 1, wherein the illuminating in each of the plurality of sample interrogation cycles comprises sequentially illuminating the sample with the two or more fluorescence excitation signals without temporal overlap.

3. The method of claim 1, wherein determining the target analyte concentration of the sample includes determining a bioburden concentration of one or more target analytes in the sample.

4. The method of claim 3, wherein the one or more target analytes include at least one of biological materials, active ingredients, or inert particles.

5. The method of claim 3, further comprising determining an amount of a particular one of the one or more target analytes in the sample.

6. The method of claim 1, wherein detecting the fluorescence emission spectral profile of the sample includes separately detecting multiple spectral sub-bands of the fluorescence emission spectral profile.

7. The method of claim 6, wherein detecting the fluorescence lifetime profile of the sample comprises detecting fluorescence emission temporal response and intensity of the sample within each of the multiple spectral sub-bands.

8. A method to analyze a sample, the method comprising:
performing a sample interrogation cycle on the sample to generate a replicate, wherein the sample interrogation cycle is performed by:
illuminating the sample with two or more fluorescence excitation signals at different fluorescence excitation wavelengths;
detecting a fluorescence emission spectral profile of the sample for each of the two or more fluorescence excitation signals to generate two or more fluorescence emission spectral profiles of the sample; and
detecting a fluorescence lifetime profile of the sample for each of the two or more fluorescence excitation signals to generate two or more fluorescence lifetime profiles of the sample;
wherein the replicate includes the two or more fluorescence emission spectral profiles and the two or more fluorescence lifetime profiles generated for the sample interrogation cycle;
performing a comparison of the replicate to a plurality of predetermined spectroscopic relationships; and
determining a target analyte concentration of the sample based on the comparison of the replicate to the plurality of predetermined spectroscopic relationships.

9. The method of claim 1, wherein the illuminating comprises sequentially illuminating the sample with the two or more fluorescence excitation signals without temporal overlap.

10. The method of claim 1, wherein determining the target analyte concentration of the sample includes determining a bioburden concentration of one or more target analytes in the sample.

11. The method of claim 10, wherein the one or more target analytes include at least one of biological materials, active ingredients, or inert particles.

12. The method of claim 10, further comprising determining an amount of a particular one of the one or more target analytes in the sample.

13. The method of claim 1, wherein detecting the fluorescence emission spectral profile of the sample includes separately detecting multiple spectral sub-bands of the fluorescence emission spectral profile.

14. The method of claim 13, wherein detecting the fluorescence lifetime profile of the sample comprises detecting fluorescence emission temporal response and intensity of the sample within each of the multiple spectral sub-bands.

15. A process monitor to analyze a sample, the process monitor comprising:
a sample zone within which the sample is present;
two or more fluorescence excitation sources optically coupled to the sample zone;
one or more detectors optically coupled to the sample zone outside an optical path of each of two or more fluorescence excitation signals emitted by the two or more fluorescence excitation sources; and
a controller communicatively coupled to each of the two or more fluorescence excitation sources and the one or more detectors and configured to control the processor monitor, including the two or more fluorescence excitation sources and the one or more detectors, to:
perform a plurality of sample interrogation cycles on the sample to generate multiple replicates, wherein each of the plurality of sample interrogation cycles is performed by:
illuminating, using the two or more fluorescence excitation sources, the sample with the two or more fluorescence excitation signals at the different fluorescence excitation wavelengths;
detecting, using the one or more detectors, a fluorescence emission spectral profile of the sample for each of the two or more fluorescence excitation signals to generate two or more fluorescence emission spectral profiles of the sample; and
detecting, using the one or more detectors, a fluorescence lifetime profile of the sample for each of the two or more fluorescence excitation signals to generate two or more fluorescence lifetime profiles of the sample;
wherein each replicate of the multiple replicates includes the two or more fluorescence emission spectral profiles and the two or more fluorescence lifetime profiles generated for a corresponding one of the plurality of sample interrogation cycles;
perform a comparison of the multiple replicates to a plurality of predetermined spectroscopic relationships; and
determine a target analyte concentration of the sample based on the comparison of the multiple replicates to the plurality of predetermined spectroscopic relationships.

16. The process monitor of claim 15, further comprising an excitation filter disposed between the sample zone and the one or more detectors, wherein the excitation filter is configured to reject wavelengths of light of at least one of the two or more fluorescence excitation signals.

17. The processor monitor of claim 15, wherein the one or more detectors includes at least two sub-band detectors, the processor monitor further comprising:
a first bandpass filter optically positioned between the sample zone and a first one of the at least two sub-band detectors, the first bandpass filter configured to direct a first detection channel to the first one of the at least two sub-band detectors and direct other wavelengths elsewhere; and
a second bandpass filter optically positioned between the sample zone and a second one of the at least two sub-band detectors, the second bandpass filter configured to direct a second detection channel that does not overlap with the first detection channel to the second one of the at least two sub-band detectors and direct other wavelengths elsewhere.

18. The processor monitor of claim 15, wherein the one or more detectors comprises a single detector, the processor monitor further comprising:
a first optical path between the sample zone and the single detector and having a first delay; and
a second optical path between the sample zone and the single detector and having a second delay that is longer than the first delay,
wherein the single detector is configured to detect both the fluorescence emission spectral profile and the fluorescence lifetime profile for each of the two more fluorescence excitation signals by, for each sample interrogation cycle:
detecting the fluorescence emission spectral profile and the fluorescence lifetime profile for a first one of the two or more fluorescence excitation signals when received from the first optical path; and
subsequently detecting later in time the fluorescence emission spectral profile and the fluorescence lifetime profile for a second one of the two or more fluorescence excitation signals when received from the second optical path.

19. The process monitor of claim 18, further comprising:
a first bandpass filter optically positioned between the first optical path and the single detector, the first bandpass filter configured to pass a first detection channel that includes the fluorescence emission spectral profile for the first one of the two or more fluorescence excitation signals to the single detector and to reject other wavelengths; and
a second bandpass filter optically positioned between the second optical path and the single detector, the second bandpass filter configured to pass a second detection channel that includes the fluorescence emission spectral profile for the second one of the two or more fluorescence excitation signals to the single detector and to reject other wavelengths.
